(19) United States
(12) Patent Application Publication
(10) Pub. No.: US 2002/0138694 A1
(43) Pub. Date: Sep. 26, 2002

(54) Magnetic disc drive, method for recording data, and method for reproducing data

(76) Inventor: Atsushi Isshiki, Saijo-shi Ehime (JP)

Correspondence Address: Allan Ratner, Ratner & Prestia, One Westlakes Berwyn Suite 301, PO Box 980, Valley Forge, PA, 19482-0980, US

(21) Appl. No.: 10/018,984

(22) PCT Filed: Apr. 23, 2001
(86) PCT No.: PCT/JP01/03471

(30) Foreign Application Priority Data
Apr. 26, 2000 (JP) 2000-125238

(51) Int. Cl. G06F 12/16

(52) U.S. Cl. 711/112; 711/162

(57) ABSTRACT

A mirroring RAID system is provided at low cost using a single magnetic disk drive. The magnetic disk drive comprises a host I/F 2 for receiving data transferred from an external host device, a magnetic disk 10 for recording data thereon, and a magnetic head 11 and preamplifier circuit 16 for recording data on the magnetic disk 10, wherein the magnetic disk drive further comprises a control CPU 5 which, based on the transfer speed of the data transferred from the external host device and on performance indices unique to the magnetic disk drive, computes the number of duplicate data recordable times representing the number of times that the transferred data can be recorded in duplicate on the magnetic disk 10, and which controls the magnetic head 11 and preamplifier circuit 16 so that the data transferred from the external host device will be recorded on the magnetic disk 10 a number of times that does not exceeds the number of duplicate data recordable times thus computed.

### TECHNICAL FIELD

The present invention relates to a magnetic disk drive that uses a magnetic disk as a recording medium and is known for providing a large capacity storage system, and also relates to a disk access method for the same.

### BACKGROUND ART

In the prior art, there have been proposed RAID systems in which a plurality of inexpensive magnetic disk drives are configured as a large capacity storage system, with provisions made to prevent failure of any single magnetic disk drive in the large capacity storage system from affecting the operation of the large capacity storage system itself.

Examples of the RAID systems proposed in the art include mirroring RAID, in which identical data is recorded on a plurality of magnetic disk drives, and striping RAID, in which data is split into a plurality of blocks of equal size and recorded across the a plurality of magnetic disk equal in number to the split blocks.

However, since the above RAID systems require the use of a plurality of magnetic disk drives, each inexpensive though, and also require the provision of a controller for data splitting and reconstruction or for synchronization of operations between the plurality of magnetic disks, they are expensive as a large capacity storage system compared with a signal magnetic disk drive of the same capacity.

FIG. 2 shows a configuration example of the prior art mirroring RAID system. When writing data, the data received via an external I/F 21 is temporarily stored in a buffer memory 22; in the case of mirroring RAID, identical data is duplicated across a plurality of magnetic disk drives (HDDs) 26. It is also necessary to synchronize operations between the HDDs 26 in order to improve the access performance of the HDDs 26.

When reading, data is read out by changing the readout magnetic disk for each access in order to prevent accesses from being concentrated on one particular magnetic disk. If a data read error occurs, another magnetic disk which is not accessed is accessed to read the data.

As a result, the configuration of a controller 20 becomes extremely complex, increasing the cost of the system as a large capacity storage device. Furthermore, while using a plurality of magnetic disks, since the storage capacity as a large capacity storage device is the same as that of a single magnetic disk drive in the system, the cost of the system becomes extremely high.

### DISCLOSURE OF THE INVENTION

In view of the prior art problems described above, it is an object of the present invention to provide a magnetic disk drive that can construct a mirroring RAID system without having to use any additional disk drives, a recording method for recording data on the magnetic disk drive, and a reproduction method for reproducing data from the magnetic disk drive.

A 1st invention of the present invention (corresponding to claim 1) is a magnetic disk drive comprising:

receiving means of receiving data transferred from an external host device;

one or more magnetic disks for recording said data thereon; and

recording means of recording said data on said magnetic disk or disks, wherein

said magnetic disk drive further comprises:

number-of-duplicate-data-recordable-times computing means of computing, based on the transfer speed of said data transferred from said external host device and on performance indices unique to said magnetic disk drive, the number of duplicate data recordable times representing the number of times that said transferred data can be recorded in duplicate on said one or more magnetic disks; and

control means of controlling said recording means so that said data transferred from said external host device will be recorded on said one or more magnetic disks a number of times that does not exceeds said number of duplicate data recordable times computed by said number-of-duplicate-data-recordable-times computing means.

A 2nd invention of the present invention (corresponding to claim 2) is a magnetic disk drive as set forth in the 1st invention, further comprising notifying means of notifying said host device of said number of duplicate data recordable times computed by said number-of-duplicate-data-recordable-times computing means, and wherein

said host device is a device that, in response to said number of duplicate data recordable times received from said notifying means, can send an instruction specifying the number of times that said data is to be recorded in duplicate on said one or more magnetic disks, and

said control means performs said control based on said instruction received from said host device.

A 3rd invention of the present invention (corresponding to claim 3) is a magnetic disk drive as set forth in the 1st invention, wherein

said host device is a device that also sends information signifying data importance together with said transferred data, and

said control means performs said control based on said information signifying said data importance received from said host device.

A 4th invention of the present invention (corresponding to claim 4) is a magnetic disk drive as set forth in any one of said 1st to 3rd inventions, further comprising area splitting means of splitting a data recording area on said magnetic disk into a plurality of areas, and wherein

said control means performs said control so that said data will be recorded in each of said split areas.

A 5th invention of the present invention (corresponding to claim 5) is a magnetic disk drive as set forth in the 4th invention, wherein said control means performs said control so that said data will be recorded in said each area which is located nearer to an outer diameter of said magnetic disk as the number of times that said data is actually recorded increases.

A 6th invention of the present invention (corresponding to claim 6) is a magnetic disk drive as set forth in any one of said 1st to 3rd inventions, wherein said data recorded in duplicate is recorded on a different one of said magnetic disks or on a different recording surface of the same magnetic disk.

A 7th invention of the present invention (corresponding to claim 7) is a magnetic disk drive as set forth in any one of said 1st to 3rd inventions, wherein said data recorded in duplicate is recorded in contiguous sectors of said magnetic disk.

An 8th invention of the present invention (corresponding to claim 8) is a magnetic disk drive as set forth in any one of said 1st to 3rd inventions, further comprising:

reproducing means of reproducing data recorded on said magnetic disk or disks; and

second control means of controlling said reproducing means so that if an error occurs when said reproducing means is reading data stored on said one or more magnetic disks, data identical to the data that caused said read error is read from a place different from the place at which said read error occurred.

A 9th invention of the present invention (corresponding to claim 9) is a data recording method comprising:

receiving data transferred from an external host device;

computing, based on the transfer speed of said data transferred from said external host device and on performance indices unique to said magnetic disk drive, the number of duplicate data recordable times representing the number of times that said transferred data can be recorded in duplicate on one or more magnetic disks; and

recording said data transferred from said external host device on said one or more magnetic disks a number of times that does not exceeds said number of duplicate data recordable times.

A 10th invention of the present invention (corresponding to claim 10) is a data reproduction method wherein if a read error occurs when reproducing data that was recorded on said one or more magnetic disks by the data recording method described in said 9th invention, data identical to the data that caused said read error is read from a place different from the place at which said read error occurred.

An 11th invention of the present invention (corresponding to claim 11) is a program for causing a computer to function as all or part of:

said receiving means of receiving data transferred from said external host device;

said recording means of recording said data on said magnetic disk or disks

said number-of-duplicate-data-recordable-times computing means of computing, based on the transfer speed of said data transferred from said external host device and on performance indices unique to said magnetic disk drive, the number of duplicate data recordable times representing the number of times that said transferred data can be recorded in duplicate on said one or more magnetic disks; and

said control means of controlling said recording means so that said data transferred from said external host device will be recorded on said one or more magnetic disks a number of times that does not exceeds said number of duplicate data recordable times computed by said number-of-duplicate-data-recordable-times computing means, in the magnetic disk drive as set forth in any one of said 1st to 7th inventions.

A 12th invention (corresponding to claim 12) of the present invention is a program for causing a computer to function as all or part of:

said reproducing means of reproducing data recorded on said magnetic disk or disks; and

said second control means of controlling said reproducing means so that if an error occurs when said reproducing means is reading data stored on said one or more magnetic disks, data identical to the data that caused said read error is read from a place different from the place at which said read error occurred, in the magnetic disk drive described in said 8th invention.

As described above, according to the magnetic disk drive as one example of the present invention, when recording data, it is determined whether it is possible to duplicate the data across a plurality of blocks within the single magnetic disk drive, and when it is possible, the data is duplicated across the plurality of blocks; if a read error occurs when reproducing the data, the data is read from a block where a duplicate is held, thus making it possible to reconstruct the requested data blocks using the correctly readout data and send out the reconstructed data.

Further, by varying the number of duplications according to the importance of data, the reduction in the amount of data recordable on the magnetic disk can be minimized. Data recorded and reproduced on the magnetic disk drive can include not only large capacity continuous data such as AV data but also ordinary computer data.

Since the magnetic disk drive described above has the function of recording a plurality of duplicate copies of data on the magnetic disk in the disk drive and reconstructing correct data from duplicate data in the event of a data error during reproduction, there is no need to provide a separate complex controller, and a mirroring RAID system can be constructed using a single magnetic disk drive; furthermore, since the disk drive has the function of managing the number of times that a duplicate can be recorded on an area by area basis, and therefore, the reduction in the amount of data recordable on the magnetic disk can be minimized, an extremely inexpensive RAID system can be provided.

To describe the invention in further detail, the magnetic disk drive as one example of the invention uses a magnetic disk as a recording medium, and accesses the magnetic disk to read or write data of various kinds of information, wherein when power is turned on to the magnetic disk drive, or when an executable command is received from the host device externally connected to it, the disk drive obtains data access performance per unit time by referring to its own performance indices, compares it with the transfer speed of separately supplied large capacity continuous data such as AV data to obtain the number of times that a duplicate of the large capacity continuous data such as AV data can be recorded, and notifies the host device accordingly.

Alternatively, the number of times that a duplicate of the large capacity continuous data such as AV data can be recorded may be reported to the host device when such information is referred to from the externally connected host device.

According to the magnetic disk drive described above, when writing the large capacity continuous data such as AV data, the magnetic disk drive can set the number of times that a duplicate of the large capacity continuous data such as AV data is created, and in this way, a mirroring RAID system can be achieved using a single magnetic disk drive.

Further, the magnetic disk drive as another example of the invention uses a magnetic disk as a recording medium, and accesses the magnetic disk to read or write data of various kinds of information, wherein when the number of times that a duplicate of large capacity continuous data such as AV data is recorded is specified from the host device externally connected to it, the disk drive compares it with the number of times that the duplicate can be recorded, and if the duplicate can be recorded up to the specified number of times, the disk drive sets the number of times that the duplicate is recorded to that specified number of times, and notifies the host system accordingly. If the duplicate cannot be recorded up to the specified number of times, the disk drive sets the number of times that the duplicate can be recorded, and notifies the host system accordingly.

According to the magnetic disk drive described above, when writing the large capacity continuous data such as AV data, the number of times that a duplicate of the large capacity continuous data such as AV data is created can be set from the host system, and in this way, a mirroring RAID system can be achieved using a single magnetic disk drive.

Further, the magnetic disk drive as another example of the invention uses a magnetic disk as a recording medium, and accesses the magnetic disk to read or write data of various kinds of information, wherein when the importance of large capacity continuous data such as AV data is specified from the host device externally connected to it, the disk drive compares it with the maximum value of the importance and the number of times that the duplicate can be recorded, obtains the number of times that the duplicate is recorded, and notifies the host system accordingly.

According to the magnetic disk drive described above, when writing the large capacity continuous data such as AV data, the number of times that a duplicate of the large capacity continuous data such as AV data is created can be set in accordance with the importance given from the host system, and in this way, a mirroring RAID system can be achieved using a single magnetic disk drive. Further, for data of low importance, the number of times that the duplicate is recorded can be reduced to minimize the reduction in the amount of data recordable on the magnetic disk.

Further, the magnetic disk drive as another example of the invention uses a magnetic disk as a recording medium, and accesses the magnetic disk to read or write data of various kinds of information, wherein when a command specifying the start and end positions or the size of the area for recording large capacity continuous data such as AV data and the number of times that a duplicate of the data is recorded in that area or the importance of the data to be recorded in that area, is received from the host device externally connected to it, the start and end positions or the size of that area and the number of times that a duplicate of the data is recorded in that area or the importance of the data to be recorded in that area are stored in memory. When a command for writing the large capacity continuous data such as AV data is received from the host system, the disk drive compares the recording position information of the data with the start and end positions or the size of that area stored in the memory, and reads out of the memory the number of times that a duplicate of the data is recorded in that area or the importance of the data for the matching area.

According to the magnetic disk drive described above, when writing the large capacity continuous data such as AV data, the number of times that a duplicate of the large capacity continuous data such as AV data is created can be set in accordance with the area that the host system accesses, and in this way, a mirroring RAID system can be achieved using a single magnetic disk drive. Further, for data of low importance, the number of times that the duplicate is recorded can be reduced to minimize the reduction in the amount of data recordable on the magnetic disk.

Further, the magnetic disk drive as another example of the invention uses a magnetic disk as a recording medium, and accesses the magnetic disk to read or write data of various kinds of information, wherein when a write command for recording large capacity continuous data such as AV data is received from the host device externally connected to it, the disk drive, after completing a write access for the large capacity continuous data such as AV data, writes a duplicate of the large capacity continuous data such as AV data successively and repeatedly in accordance with the number of times that the duplicate is to be recorded.

According to the magnetic disk drive described above, when writing the large capacity continuous data such as AV data, a duplicate of the large capacity continuous data such as AV data can be recorded in accordance with the number of times that the duplicate is created, and in this way, a mirroring RAID system can be achieved using a single magnetic disk drive.

Further, the magnetic disk drive as another example of the invention uses a magnetic disk as a recording medium, and accesses the magnetic disk to read or write data of various kinds of information, wherein when a write command for recording large capacity continuous data such as AV data is received from the host device externally connected to it, the disk drive, after completing a write access for the large capacity continuous data such as AV data, changes the magnetic heads mounted in the magnetic disk drive and writes a duplicate of the large capacity continuous data such as AV data successively and repeatedly in accordance with the number of times that the duplicate is to be recorded.

According to the magnetic disk drive described above, when writing the large capacity continuous data such as AV data, a duplicate of the large capacity continuous data such as AV data can be recorded using different magnetic heads in accordance with the number of times that the duplicate is created, and in this way, a mirroring RAID system can be achieved using a single magnetic disk drive. Furthermore, even if any one of the magnetic heads mounted in the magnetic disk drive fails, all duplicate data can be accessed using another normally operating magnetic head; this serves to improve the fault tolerance of the mirroring RAID system constructed using a single magnetic disk drive.

Further, the magnetic disk drive as another example of the invention uses a magnetic disk as a recording medium, and accesses the magnetic disk to read or write data of various kinds of information, wherein when a write command for recording large capacity continuous data such as AV data is received from the host device externally connected to it, the disk drive, after completing a write access to a single sector for the large capacity continuous data such as AV data, writes a duplicate of the single sector for the large capacity continuous data such as AV data successively and repeatedly in accordance with the number of times that the duplicate is to be recorded.

According to the magnetic disk drive described above, when writing the large capacity continuous data such as AV data, a duplicate of the large capacity continuous data such as AV data can be recorded in accordance with the number of times that the duplicate is created, and in this way, a mirroring RAID system can be achieved using a single magnetic disk drive.

Further, the magnetic disk drive as another example of the invention uses a magnetic disk as a recording medium, and accesses the magnetic disk to read or write data of various kinds of information, wherein when a read command for reproducing large capacity continuous data such as AV data is received from the host device externally connected to it, if an access has successfully been made to the large capacity continuous data such as AV data, the data is transferred to the host system; on the other hand, if an error occurs when an access is made to the large capacity continuous data such as AV data, then an access is made to an area where duplicate data of the large capacity continuous data such as AV data is recorded, and if an access has successfully been made to the duplicate data of the large capacity continuous data such as AV data, the data is transferred to the host system. Further, when the duplicate data sector corresponding to the error sector has been read out correctly, the correctly readout data is written over the error sector so that the data can be read out correctly the next time it is accessed.

According to the magnetic disk drive described above, when reading the large capacity continuous data such as AV data, if a read error occurs, correct data can be read from duplicate data of the large capacity continuous data such as AV data, and in this way, a mirroring RAID system can be achieved using a single magnetic disk drive.

### BRIEF DESCRIPTION OF THE DRAWINGS

FIG. 1 is a diagram showing the configuration of a magnetic disk drive according to first, second, third, fourth, fifth, sixth, seventh, and eighth embodiments of the present invention.

FIG. 2 is a diagram showing the configuration of a prior art mirroring RAID system.

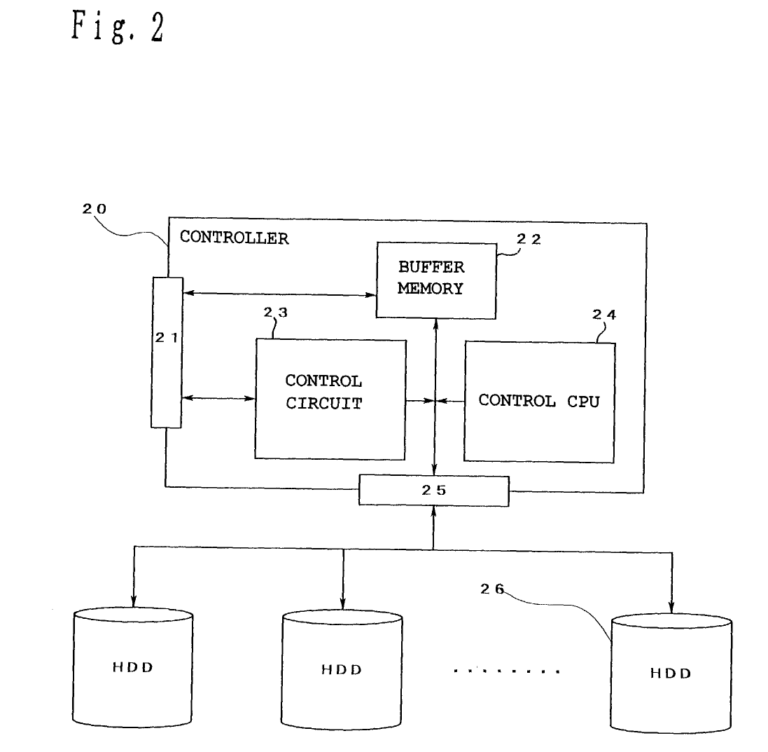

FIG. 3 is a diagram for explaining the operation of the magnetic disk drive according to the first embodiment of the present invention.

FIG. 4 is a diagram for explaining the operation of the magnetic disk drive according to the second embodiment of the present invention.

FIG. 5 is a diagram for explaining the operation of the magnetic disk drive according to the third embodiment of the present invention.

FIG. 6 is a diagram for explaining the operation of the magnetic disk drive according to the fourth embodiment of the present invention.

FIG. 7 is a diagram for explaining the operation of the magnetic disk drive according to the fifth embodiment of the present invention.

FIG. 8 is a diagram for explaining the operation of the magnetic disk drive according to the sixth embodiment of the present invention.

FIG. 9 is a diagram for explaining the operation of the magnetic disk drive according to the seventh embodiment of the present invention.

FIG. 10 is a diagram for explaining the operation of the magnetic disk drive according to the eighth embodiment of the present invention.

### DESCRIPTION OF THE REFERENCE NUMERALS

1. PCB BLOCK

2, 21. HOST I/F

3, 23. CONTROL CIRCUIT

4, 22. BUFFER MEMORY

5. 24. CONTROL CPU

6. MOTOR DRIVER CIRCUIT

7. R/W CHANNEL CIRCUIT

8. CONTROL SIGNAL LINE AND DATA SIGNAL LINE

9. HDA BLOCK

10. MAGNETIC DISK

11. MAGNETIC HEAD

12. SPINDLE MOTOR

13. VCM MOTOR

14. ACTUATOR

15. FPCB

16. PREAMPLIFIER CIRCUIT

20. CONTROLLER

25. MAGNETIC DISK I/F

26. MAGNETIC DISK DRIVE

### BEST MODE FOR CARRYING OUT THE INVENTION

Embodiments of the present invention will be described below with reference to drawings.

(Embodiment 1)

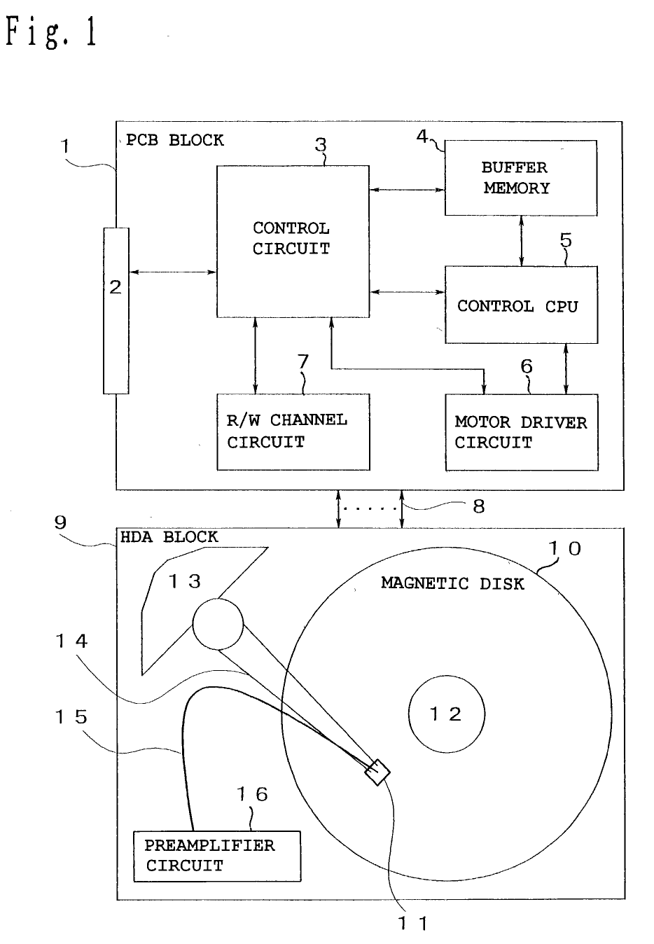

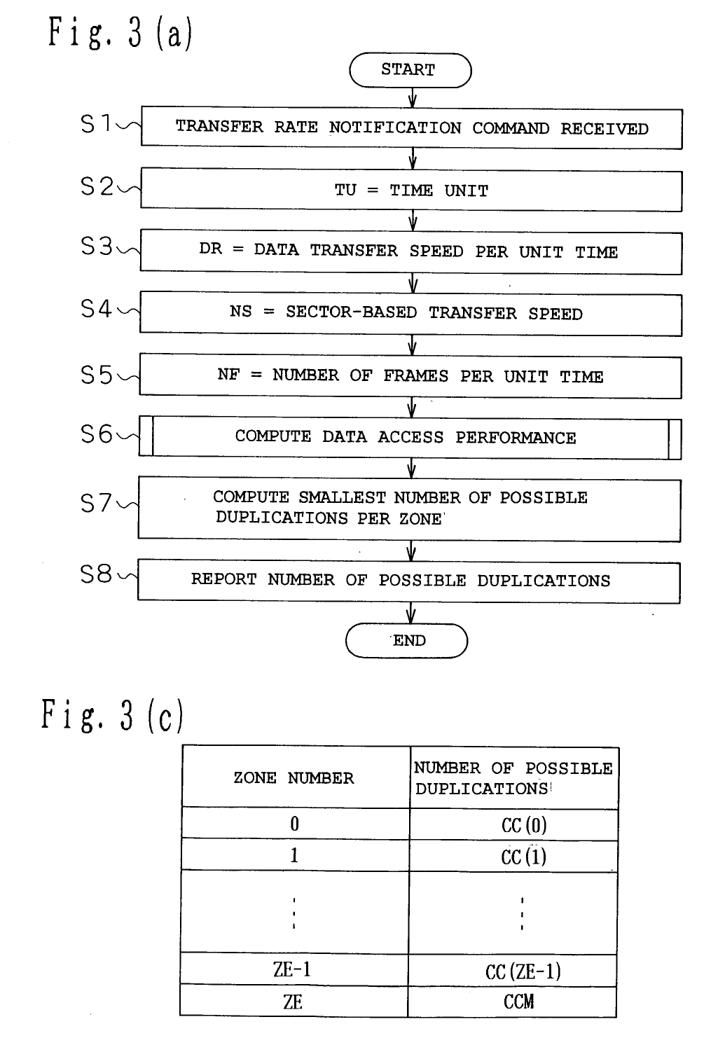

The configuration of a magnetic disk drive according to a first embodiment of the present invention will be described below along with its operation with reference to FIGS. 1 and 3.

FIG. 1 is a block diagram showing the configuration of a mirroring RAID system using a single magnetic disk drive according to the embodiment of the present invention. The magnetic disk drive of the embodiment comprises a PCB block 1 for controlling the disk drive and an HDA block 9 for recording and reproducing data.

The PCB block 1 comprises a host I/F2 for connecting to a host system, a system controller (control circuit) 3 for transferring data and commands or status to and from the host system, a control CPU 5, a buffer memory 4 for holding data or control information, a motor driver circuit 6 for controlling various motors in the HDA block 9, and an R/W channel circuit 7 for controlling data streams for recording or reproduction in the HDA block 9.

The HDA block 9 comprises one or more magnetic disks 10 for holding data thereon, a spindle motor 12 for rotating the magnetic disk 10, one or more magnetic heads 11 for recording data on or reproducing data from the magnetic disk 10, an actuator 14 for supporting the magnetic head 11 thereon, a VCM motor 13 for driving the actuator 14, an FPCB 15 for transferring data signals between the magnetic head 11 and a preamplifier circuit 16, and the preamplifier circuit 16 for amplifying the data signals transferred via the FPCB 15.

The PCB block 1 and the HDA block 9 are connected by control and data signal lines 8.

Performance indices of the magnetic disk drive of the embodiment, such as the number of revolutions of the spindle motor 12, switching time of the magnetic head 11, cylinder seek time, number of magnetic heads 11, number of sectors per track on the magnetic disk 10, and number of zones classified according to a parameter such as the recording density on the magnetic disk 10, are recorded in a specific area on the magnetic disk 10.

The performance indices of the magnetic disk drive of the embodiment, such as the number of revolutions of the spindle motor 12, switching time of the magnetic head 11, cylinder seek time, number of magnetic heads 11, number of sectors per track on the magnetic disk 10, and number of zones classified according to a parameter such as the recording density on the magnetic disk 10, which are recorded in the specific area on the magnetic disk 10, are read from the magnetic disk 10 by the control CPU 5 via the R/W channel circuit 7 and control circuit 3, and stored in the buffer memory 4 or in a memory or register in the control CPU 5.

When a command notifying the transfer rate of large capacity continuous data such as AV data is received from the host system via the host I/F 2 (step 1 in FIG. 3), then as shown in FIG. 3(a) the control CPU 5 reads from the control circuit 3 the reference time unit by which the data transfer rate is measured (hereinafter designated by a variable TU) (step 2), reads the transfer speed of data transferred in unit time (hereinafter designated by a variable DR) (step 3), reads the sector-based transfer speed expressing the transfer speed of data transferred in unit time in terms of the number of sectors (hereinafter designated by a variable NS) (step 4), and reads the number of frames per unit time indicating the number of frames across which data to be transferred in unit time is divided for transfer (hereinafter designated by a variable NF) (step 5).

Next, as shown in FIG. 3(b), the control CPU 5 initializes the zone number (hereinafter designated by a variable ZN), the zones being classified according to a parameter such as the recording density on the magnetic disk 10, so that it points to the start position (step 6-1) , and sets the zone number indicating the end position (hereinafter designated by a variable ZE) to the value that the magnetic disk drive has (step 6-2). In the example shown in FIG. 3(b), 0 is assigned as ZN which increments in increasing order.

Further, as shown in FIG. 3(b), the control CPU 5 sets the number of revolutions of the spindle motor 12 (hereinafter designated by a variable SS) to the value that the magnetic disk drive has (step 6-3), and computes the time that the spindle motor 12 takes to make one revolution (hereinafter designated by a variable TR) (step 6-4).

The control CPU 5 next sets the head switching time required to switch from one magnetic head 11 to another to access a different recording surface of the magnetic disk 10 (hereinafter designated by a variable HS) to the value that the magnetic disk drive has (step 6-5), sets the cylinder seek time required to switch between cylinders arranged on the recording surface of the magnetic disk 10 to access a different cylinder (hereinafter designated by a variable CS) to the value that the magnetic disk drive has (step 6-6), and sets the number of magnetic heads 11 mounted in the magnetic disk drive (hereinafter designated by a variable NH) to the value that the magnetic disk drive has (step 6-7).

Next, the control CPU 5 performs the following processing on all zones. First, the number of sectors per track (hereinafter designated by a variable ST), which varies from zone to zone, is set to the value that the magnetic disk drive has (step 6-10), and the number of sectors of data transferred in unit time is converted into the number of tracks in the corresponding zone (hereinafter designated by a variable NT) (step 6-10).

Next, the control CPU 5 computes the number of sectors falling short of one track (hereinafter designated by a variable LS) (step 6-11), and adds 1 to NT if LS is not 0 (step 6-12). Then, the control CPU 5 computes the number of cylinder seeks that occur when transferring data (hereinafter designated by a variable NCS) (step 6-15), and also computes the number of head 11 switches (hereinafter designated by a variable NHS) (step 6-16).

Then, the control CPU 5 computes the total time required for the data transferred in unit time to be written to the magnetic disk drive (hereinafter designated by a variable TT) by summing the total of track access times {(NT−1)*TR}, the access time for the sectors falling short of one track {(LS/ST)*TR}, the total of cylinder seek times {NCS*CS}, and the total of head 11 switching times {NHS*HS} (step 6-17). In this specification and the drawings given herein, the symbol “*” indicates a multiplication. Further, the symbol “%” in step 6-12 in FIG. 3(b) indicates a calculation to obtain a remainder.

Next, the control CPU 5 computes the number of times that a duplicate of transferred data can be created in unit time (hereinafter designated by a variable CC) based on the transfer speed of the data and the earlier described performance indices of the disk drive (step 6-18), and records it in a table that is indexed by zone number, as shown in FIG. 3(c). The table is stored in the buffer memory 4. Next, the control CPU 5 increments ZN by 1 to advance the zone to be processed to the next (step 6-19). If ZN exceeds ZE, it is determined that the processing has been completed on all the zones, and the process is terminated.

Next, the control CPU 5 computes the smallest value of CC (hereinafter designated by a variable CCM) of all the zones (step 7), and records it into the memory 4. In the example shown in FIG. 3(c), the CCM is stored in the last entry of the table carrying the CC for each zone so that it can be easily referenced. The control CPU 5 sends the CCM to the host system via the control circuit 3 and host I/F 2 as a value representing the number of times that a duplicate of the large capacity continuous data such as AV data can be created in the disk drive.

During the normal operation of the mirroring RAID system constructed from the single magnetic disk drive of the first embodiment of the invention, the table of FIG. 3(c) is stored in the buffer memory 4, but it can also be recorded on the magnetic disk 10.

As described above, according to the magnetic disk drive of the first embodiment, when writing large capacity continuous data such as AV data, the number of times that a duplicate of the data is created can be determined based on the transfer speed of the large capacity continuous data such as AV data and the performance indices of the magnetic disk drive, and in this way, a mirroring RAID system can be achieved using a single magnetic disk drive.

(Embodiment 2)

Next, the configuration of a magnetic disk drive according to a second embodiment of the present invention will be described below along with its operation with reference to FIGS. 1, 3, and 4.

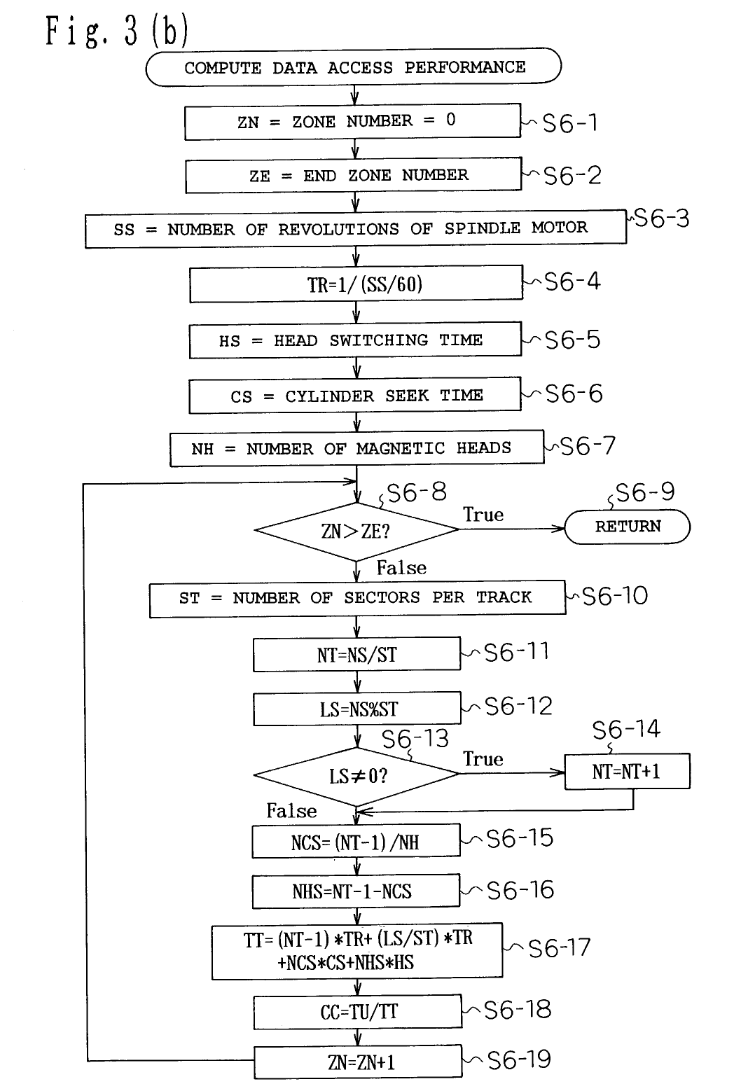

First, when a command specifying the number of times that a duplicate of large capacity continuous data such as AV data is created is received from the host system via the host I/F 2, then as shown in FIG. 4 the control CPU 5 reads from the control circuit 3 the number of times that a duplicate of large capacity continuous data such as AV data is created (hereinafter designated by a variable NC) (step 12), and compares it with the smallest number of times that a duplicate of large capacity continuous data such as AV data can be created in the disk drive (hereinafter designated by a variable CCM), as shown in FIG. 3(c) (step 13); if NC is larger than CCM, NC is set equal to CCM (step 14), and this NC is sent to the host system via the control circuit 3 and host I/F 2 as a value representing the number of times that a duplicate of the large capacity continuous data such as AV data can be created in the disk drive.

According to the magnetic disk drive of this embodiment, when writing large capacity continuous data such as AV data, the number of times that a duplicate of large capacity continuous data such as AV data is created can be set from the host system, and in this way, a mirroring RAID system can be achieved using a single magnetic disk drive.

(Embodiment 3)

Next, the configuration of a magnetic disk drive according to a third embodiment of the present invention will be described below along with its operation with reference to FIGS. 1, 3, and 5.

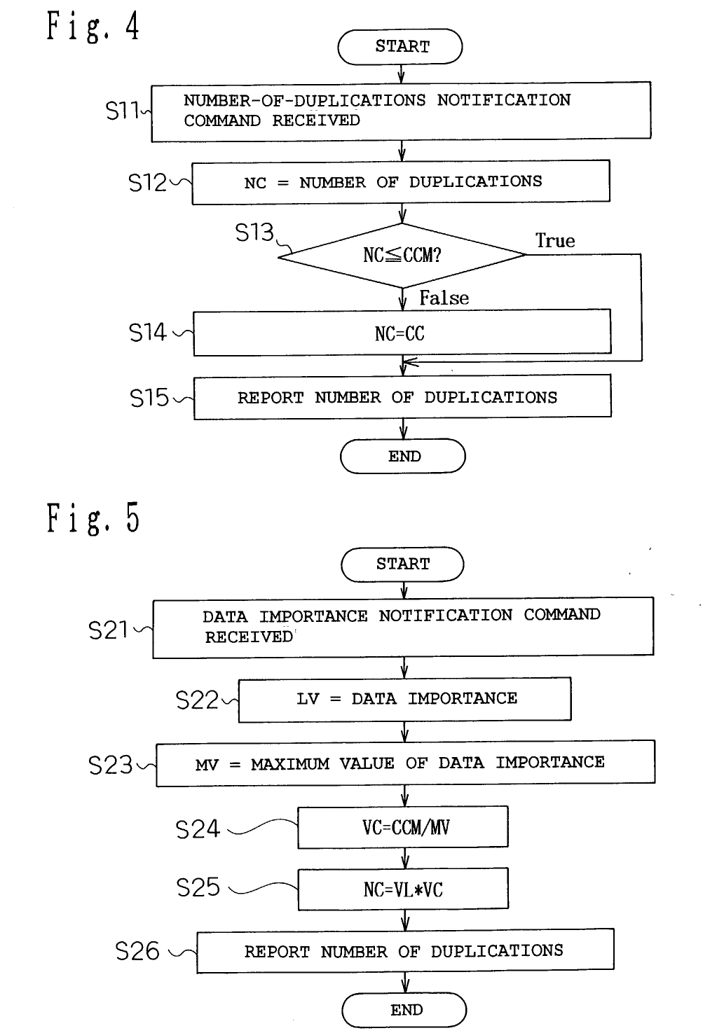

First, when a command specifying the importance of large capacity continuous data such as AV data is received from the host system via the host I/F 2, then as shown in FIG. 5 the control CPU 5 reads the importance of large capacity continuous data such as AV data (hereinafter designated by a variable LV) (step 22), reads the maximum value of the importance of large capacity continuous data such as AV data (hereinafter designated by a variable MV) (step 23), compares it with CCM shown in FIG. 3(c) and computes the number of times that a duplicate can be created per importance of units (hereinafter designated by a variable VC) (step 24), computes the number of times that a duplicate is created (hereinafter designated by a variable NC) corresponding to the specified importance (step 25), and reports it to the host system via the host I/F 2 (step 26).

According to the magnetic disk drive of this embodiment, when writing large capacity continuous data such as AV data, the number of times that a duplicate of large capacity continuous data such as AV data is created can be set from the host system by specifying the importance of the large capacity continuous data such as AV data, and in this way, a mirroring RAID system can be achieved using a single magnetic disk drive.

(Embodiment 4)

Next, the configuration of a magnetic disk drive according to a fourth embodiment of the present invention will be described below along with its operation with reference to FIGS. 1, 3, and 6.

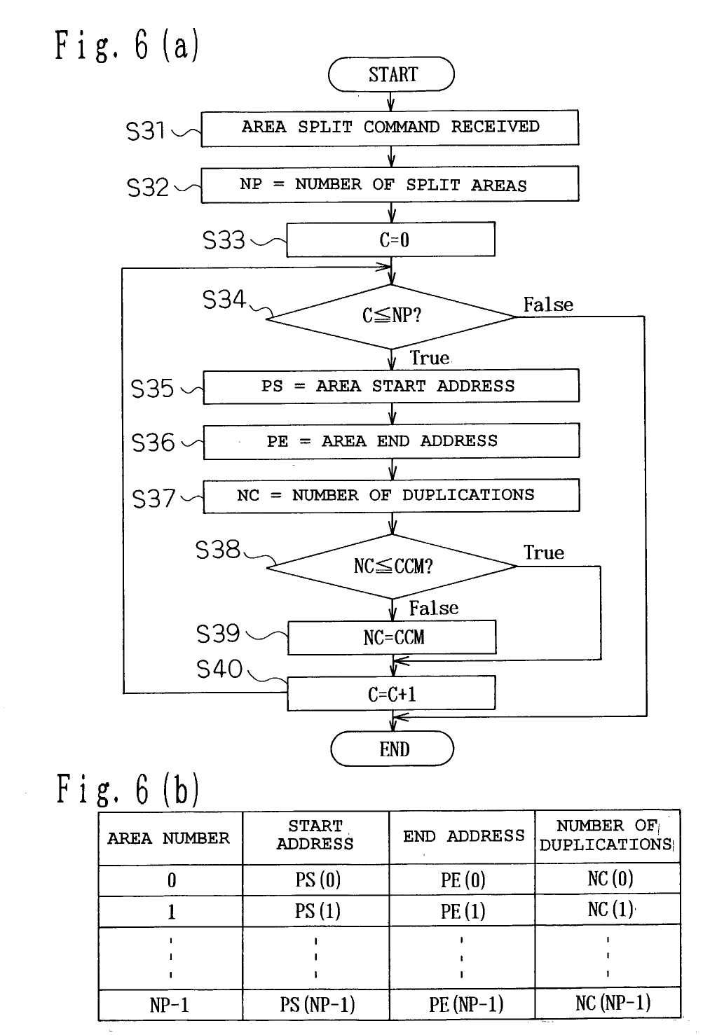

First, when a command specifying the area for recording large capacity continuous data such as AV data and also specifying the importance of the data or the number of times that a duplicate of the data is created is received from the host system via the host I/F 2, then as shown in FIG. 6(a) the control CPU 5 reads from the control circuit 3 the number by which the area for recording the large capacity continuous data such as AV data is to be divided (hereinafter designated by a variable NP) (step 32), initializes the number used to determine whether information relating to all the areas has been read out (hereinafter designated by a variable C) to 0 (step 33) and repeats the following process as long as C is equal to or smaller than NV.

First, the control CPU 5 reads from the control circuit 3 the start position of the area for recording the large capacity continuous data such as AV data (hereinafter designated by a variable PS) (step 35), records it in a table that is indexed by area number as shown in FIG. 6(b), reads the end position (hereinafter designated by a variable PE) (step 36), records it in the table that is indexed by area number as shown in FIG. 6(b), reads the number of times that a duplicate of large capacity continuous data such as AV data is created (hereinafter designated by a variable NC) (step 37), compares it with CCM shown in FIG. 3(c) (step 38), sets NC equal to CCM if NC is larger than CCM (step 39), and enters this NC as the number of times that a duplicate of large capacity continuous data such as AV data can be created in the present embodiment, into the table that is indexed by area number as shown in FIG. 6(b).

The information indicating the start position and end position of the area for recording the large capacity continuous data such as AV data may instead be information indicating the start position and length of the area. Further, the number of times that a duplicate of large capacity continuous data such as AV data is created may instead be the importance of the data.

During the normal operation of the mirroring RAID system constructed from the single magnetic disk drive of this embodiment, the table of FIG. 6(b) is stored in the buffer memory 4, but it can also be recorded on the magnetic disk 10.

According to the magnetic disk drive of this embodiment, when writing large capacity continuous data such as AV data, the number of times that a duplicate of large capacity continuous data such as AV data is created can be set from the host system for each area on the magnetic disk, so that the reduction in the recording capacity can be minimized in the mirroring RAID system constructed on the single magnetic disk drive.

(Embodiment 5)

Next, the configuration of a magnetic disk drive according to a fifth embodiment of the present invention will be described below along with its operation with reference to FIGS. 1, 3, 6, and 7.

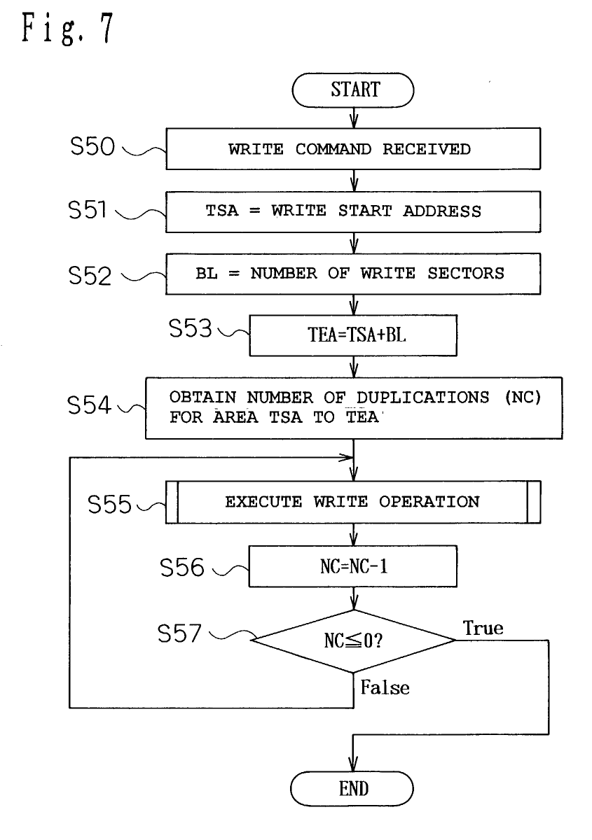

First, when a command for recording large capacity continuous data such as AV data is received from the host system via the host I/F 2, then as shown in FIG. 7 the control CPU 5 reads from the control circuit 3 the address on the magnetic disk at which the recording of the data is to be started (hereinafter designated by a variable TSA) (step 51), reads the number of sectors used to record the data (hereinafter designated by a variable BL) (step 52), and finds the address at which the recording of the data is to be completed (hereinafter designated by a variable TEA) (step 53).

Next, the control CPU 5 reads the number of times that a duplicate is created (hereinafter designated by a variable NC) for the data writing area by referring to the area management table shown in FIG. 6(b). Next, the control CPU 5 and control circuit 3 store the data transferred via the host I/F 2 into the buffer memory 4, and the data is written to the magnetic disk 10 via the control circuit 3 and R/W channel circuit 7; here, if the value obtained by subtracting 1 from NC is not 0, a duplicate of the data stored in the buffer memory 4 is written to the next contiguous area on the magnetic disk 10 via the control circuit 3 and R/W channel circuit 7.

The control CPU 5 and control circuit 3 continue to write a duplicate of the data stored in the buffer memory 4 to each subsequent contiguous area on the magnetic disk 10 via the control circuit 3 and R/W channel circuit 7 until the value obtained by subtracting 1 from NC becomes 0.

By using the magnetic disk drive of this embodiment, it becomes possible to automatically create a duplicate when writing large capacity continuous data such as AV data, and thus a mirroring RAID system can be achieved using a single magnetic disk drive.

(Embodiment 6)

Next, the configuration of a magnetic disk drive according to a sixth embodiment of the present invention will be described below along with its operation with reference to FIGS. 1, 3, 6, and 8.

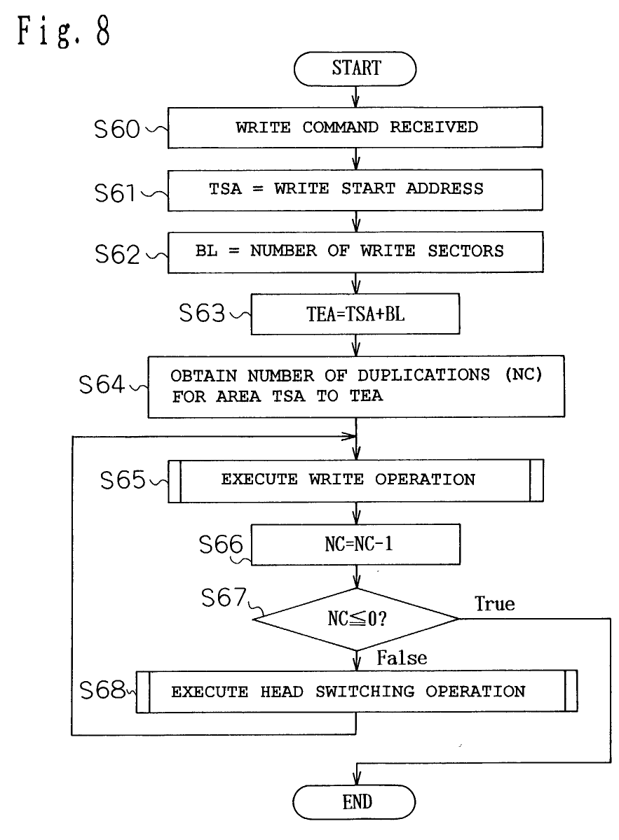

First, when a command for recording large capacity continuous data such as AV data is received from the host system via the host I/F 2, then as shown in FIG. 8 the control CPU 5 reads from the control circuit 3 the address on the magnetic disk at which the recording of the data is to be started (hereinafter designated by a variable TSA) (step 61), reads the number of sectors used to record the data (hereinafter designated by a variable BL) (step 62), and finds the address at which the recording of the data is to be completed (hereinafter designated by a variable TEA) (step 63).

Next, the control CPU 5 reads the number of times that a duplicate is created (hereinafter designated by a variable NC) for the data writing area by referring to the area management table shown in FIG. 6(b) (step 64). Next, the control CPU 5 and control circuit 3 store the data transferred via the host I/F 2 into the buffer memory 4, and the data is written to the magnetic disk 10 via the control circuit 3 and R/W channel circuit 7; here, if the value obtained by subtracting 1 from NC is not 0, a duplicate of the data transferred via the host I/F 2 is written to a different recording surface of the magnetic disk 10 (the other recording surface of the same magnetic disk 10 or a recording surface of another magnetic disk 10) by changing the magnetic heads 11.

The control CPU 5 and control circuit 3 continue to write a duplicate of the data stored in the buffer memory 4 by changing the magnetic heads 11 until the value obtained by subtracting 1 from NC becomes 0.

By using the magnetic disk drive of this embodiment, it becomes possible to automatically create a duplicate when writing large capacity continuous data such as AV data, and thus a mirroring RAID system can be achieved using a single magnetic disk drive.

(Embodiment 7)

Next, the configuration of a magnetic disk drive according to a seventh embodiment of the present invention will be described below along with its operation with reference to FIGS. 1, 3, 6, and 9.

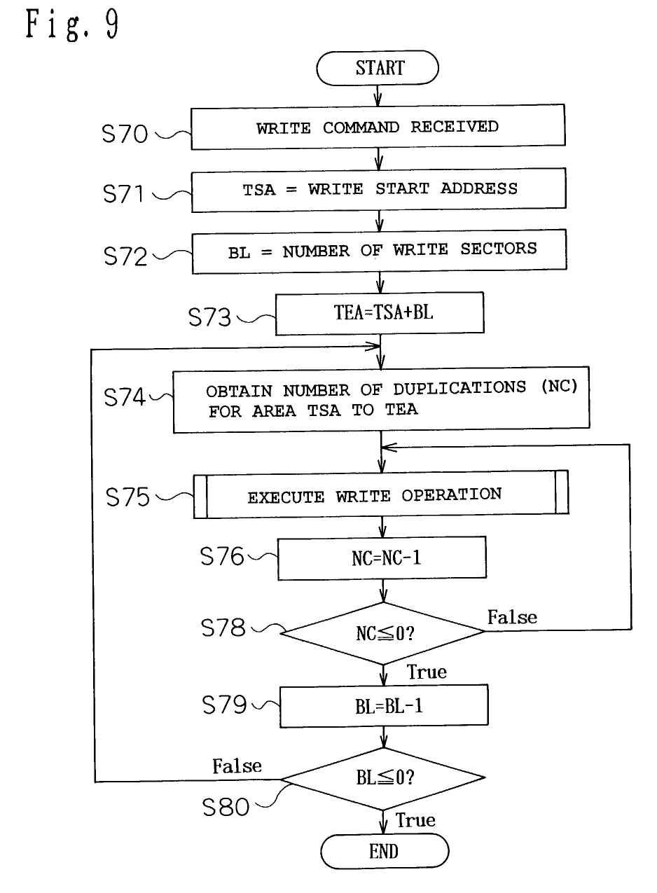

First, when a command for recording large capacity continuous data such as AV data is received from the host system via the host I/F 2, then as shown in FIG. 9 the control CPU 5 reads from the control circuit 3 the address on the magnetic disk at which the recording of the data is to be started (hereinafter designated by a variable TSA) (step 71), reads the number of sectors used to record the data (hereinafter designated by a variable BL) (step 72), and finds the address at which the recording of the data is to be completed (hereinafter designated by a variable TEA) (step 73).

Next, the control CPU 5 reads the number of times that a duplicate is created (hereinafter designated by a variable NC) for the data writing area by referring to the area management table shown in FIG. 6(b) (step 74). Next, the control CPU 5 and control circuit 3 store the data transferred via the host I/F 2 into the buffer memory 4, and write only one sector to the magnetic disk 10 via the control circuit 3 and R/W channel circuit 7; here, if the value obtained by subtracting 1 from NC is not 0, a duplicate of the data stored in the buffer memory 4 is written to the next continuous sector. The control CPU 5 and control circuit 3 continue to write a duplicate of the data stored in the buffer memory 4 to each subsequent sector until the value obtained by subtracting 1 from NC becomes 0.

When the value obtained by subtracting 1 from NC becomes 0, if the value obtained by subtracting 1 from BL is not 0, the control CPU 5 and control circuit 3 reset NC to the initial value and perform processing to write the next sector. When the value obtained by subtracting 1 from BL becomes 0, the control CPU 5 and control circuit 3 terminate the process.

By using the magnetic disk drive of this embodiment, it becomes possible to automatically create a duplicate when writing large capacity continuous data such as AV data, and thus a mirroring RAID system can be achieved using a single magnetic disk drive.

(Embodiment 8)

Next, the configuration of a magnetic disk drive according to an eighth embodiment of the present invention will be described below along with its operation with reference to FIGS. 1, 3, and 10.

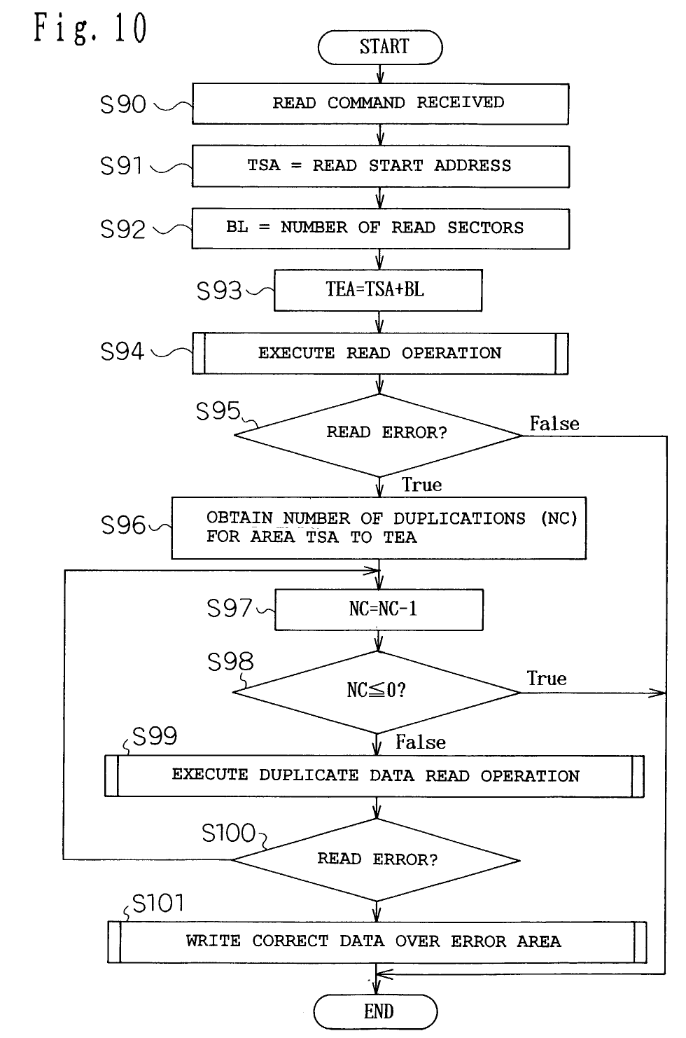

First, when a command for reproducing large capacity continuous data such as AV data is received from the host system via the host I/F 2, then as shown in FIG. 10 the control CPU 5 reads from the control circuit 3 the address on the magnetic disk at which the reproduction of the data is to be started (hereinafter designated by a variable TSA) (step 91), reads the number of sectors used to record the data (hereinafter designated by a variable BL) (step 92), and finds the address at which the recording of the data is to be completed (hereinafter designated by a variable TEA) (step 93).

Next, the control CPU 5 and control circuit 3 read the data stored on the magnetic disk 10 into the buffer memory 4 via the R/W channel circuit 7 and, if there is no error, transfers the data stored in the buffer memory 4 to the host system via the host I/F 2.

If an error occurs, the control CPU 5 reads the number of times that a duplicate was created when writing the data (hereinafter designated by a variable NC) by referring to the area management table shown in FIG. 6(b) (step 96). If the value obtained by subtracting 1 from NC is not 0, the control CPU 5 and control circuit 3 read the data of the error sector from the area on the magnetic disk 10 where the duplicate is recorded, and store the readout data in the buffer memory 4; here, if there is no error, the data stored in the buffer memory 4 is transferred to the host system via the host I/F 2. If an error occurs, the control CPU 5 and control circuit 3 repeat the above operation until the value obtained by subtracting 1 from NC becomes 0 or until data can be read out without error from the area where the duplicate is recorded.

When the data is read out without error from the area where the duplicate is recorded, the control CPU 5 and control circuit 3 write the correct data to the error sector.

By using the magnetic disk drive of this embodiment, if an error occurs when reading large capacity data such as AV data, correct data can be read out from the area where a duplicate is recorded, and be transferred to the host system, and in this way, a mirroring RAID system can be achieved using a single magnetic disk drive.

As described above, according to the magnetic disk drive and its control method in each embodiment of the present invention, when recording AV data or other important data, a plurality of duplicate copies of the data can be recorded on a single magnetic disk. Furthermore, by varying the number of duplications according to the importance of the duplicate data, the reduction in the amount of data recordable on the magnetic disk can be minimized.

Further, when reading AV data or other important data, if an uncorrectable error occurs, data free from error can be read out by reading a duplicate of the data from the plurality of duplicate copies recorded on the single magnetic disk. Accordingly, an inexpensive mirroring RAID system can be constructed using a single magnetic disk drive.

In the magnetic disk drive according to each embodiment of the present invention, when creating a duplicate, the number of duplications that can be produced in unit time can be determined based on the performance indices of the magnetic disk drive; this has the effect of minimizing data dropouts when transferring large capacity continuous data such as AV data that requires the transfer of a prescribed amount of data within a finite time.

In the above embodiments, the performance indices of the magnetic disk drive have been described as including the number of revolutions of the spindle motor 12, switching time of the magnetic head 11, cylinder seek time, number of magnetic heads 11, number of sectors per track on the magnetic disk 10, and number of zones classified according to a parameter such as the recording density on the magnetic disk 10, but the performance indices of the magnetic disk drive of the present invention are not limited to those listed above. Only part of those listed above may be used or the number of magnetic disks 10, etc. may be included in the performance indices.

In short, in the magnetic disk drive of the present invention, the number of times that transferred data can be duplicated for recording is determined based on the performance indices of the magnetic disk drive and on the transfer speed of the data transferred from an external device.

In the above-described embodiments, the host I/F 2 has been used as an example of receiving means in the magnetic disk drive of the present invention, the magnetic head 11 and preamplifier circuit 16 as an example of recording means, and the control CPU 5 as an example of number-of-duplicate-data-recordable-times computing means. The host I/F 2 is also used as an example of communication means.

Further, the magnetic disk drive of each embodiment of the invention may be configured so that the duplicate data is recorded in an area which is located nearer to the outer diameter of the magnetic disk 10 as the number of times that the data is actually recorded increases. For example, the recording area for recording the same data by duplicating five times may be located nearer to the outer diameter than the recording area for recording the same data by duplicating three times is.

The present invention also provides a program for causing a computer to carry out the functions of all or part of the means of the magnetic disk drive of the invention, wherein the program operates in collaboration with the computer.

Here, part of the means of the invention refers to some of the plurality of means or some of the functions in one of the means.

A computer readable recording medium with the program of the invention recorded thereon is also included in the present invention.

In one utilization mode of the program of the invention, the program may be recorded on a recording medium readable by a computer, and operated in collaboration with the computer.

In another utilization mode of the program of the invention, the program may be transmitted through a transmission medium, read by a computer, and operated in collaboration with the computer.

The recording medium includes a ROM or the like, and the transmission medium includes a transmission medium such as the Internet, light waves, radio waves, or sound waves.

The computer of the invention described above is not limited to pure hardware such as a CPU, but may include firmware, an OS, or even a peripheral device.

Further, as described above, the configuration of the invention may be implemented in software or in hardware.

Potential for Utilization in Industry

As is apparent from the above description, the present invention is able to provide a magnetic disk drive that can construct a mirroring RAID system without having to use any additional disk drives, a recording method for recording data on the magnetic disk drive, and a reproduction method for reproducing data from the magnetic disk drive.

What is claimed is:

1. A magnetic disk drive comprising:
receiving means of receiving data transferred from an external host device;
one or more magnetic disks for recording said data thereon; and
recording means of recording said data on said magnetic disk or disks, wherein
said magnetic disk drive further comprises:
number-of-duplicate-data-recordable-times computing means of computing, based on the transfer speed of said data transferred from said external host device and on performance indices unique to said magnetic disk drive, the number of duplicate data recordable times representing the number of times that said transferred data can be recorded in duplicate on said one or more magnetic disks; and
control means of controlling said recording means so that said data transferred from said external host device will be recorded on said one or more magnetic disks a number of times that does not exceeds said number of duplicate data recordable times computed by said number-of-duplicate-data-recordable-times computing means.

2. A magnetic disk drive as set forth in claim 1, further comprising notifying means of notifying said host device of said number of duplicate data recordable times computed by said number-of-duplicate-data-recordable-times computing means, and wherein
said host device is a device that, in response to said number of duplicate data recordable times received from said notifying means, can send an instruction specifying the number of times that said data is to be recorded in duplicate on said one or more magnetic disks, and
said control means performs said control based on said instruction received from said host device.

3. A magnetic disk drive as set forth in claim 1, wherein
said host device is a device that also sends information signifying data importance together with said transferred data, and
said control means performs said control based on said information signifying said data importance received from said host device.

4. A magnetic disk drive as set forth in any one of claims 1 to 3, further comprising area splitting means of splitting a data recording area on said magnetic disk into a plurality of areas, and wherein
said control means performs said control so that said data will be recorded in each of said split areas.

5. A magnetic disk drive as set forth in claim 4, wherein said control means performs said control so that said data will be recorded in said each area which is located nearer to an outer diameter of said magnetic disk as the number of times that said data is actually recorded increases.

6. A magnetic disk drive as set forth in any one of claims 1 to 3, wherein said data recorded in duplicate is recorded on a different one of said magnetic disks or on a different recording surface of the same magnetic disk.

7. A magnetic disk drive as set forth in any one of claims 1 to 3, wherein said data recorded in duplicate is recorded in contiguous sectors of said magnetic disk.

8. A magnetic disk drive as set forth in any one of claims 1 to 3, further comprising:
reproducing means of reproducing data recorded on said magnetic disk or disks; and
second control means of controlling said reproducing means so that if an error occurs when said reproducing means is reading data stored on said one or more magnetic disks, data identical to the data that caused said read error is read from a place different from the place at which said read error occurred.

9. A data recording method comprising:
receiving data transferred from an external host device;
computing, based on the transfer speed of said data transferred from said external host device and on performance indices unique to said magnetic disk drive, the number of duplicate data recordable times representing the number of times that said transferred data can be recorded in duplicate on one or more magnetic disks; and
recording said data transferred from said external host device on said one or more magnetic disks a number of times that does not exceeds said number of duplicate data recordable times.

10. A data reproduction method wherein if a read error occurs when reproducing data that was recorded on said one or more magnetic disks by the data recording method described in claim 9, data identical to the data that caused said read error is read from a place different from the place at which said read error occurred.

11. A program for causing a computer to function as all or part of:
said receiving means of receiving data transferred from said external host device;
said recording means of recording said data on said magnetic disk or disks
said number-of-duplicate-data-recordable-times computing means of computing, based on the transfer speed of said data transferred from said external host device and on performance indices unique to said magnetic disk drive, the number of duplicate data recordable times representing the number of times that said transferred data can be recorded in duplicate on said one or more magnetic disks; and
said control means of controlling said recording means so that said data transferred from said external host device will be recorded on said one or more magnetic disks a number of times that does not exceeds said number of duplicate data recordable times computed by said number-of-duplicate-data-recordable-times computing means, in the magnetic disk drive described in claim 1.

12. A program for causing a computer to function as all or part of:
said reproducing means of reproducing data recorded on said magnetic disk or disks; and
said second control means of controlling said reproducing means so that if an error occurs when said reproducing means is reading data stored on said one or more magnetic disks, data identical to the data that caused said read error is read from a place different from the place at which said read error occurred, in the magnetic disk drive described in claim 8.
